(19) United States
(12) Patent Application Publication
(10) Pub. No.: US 2004/0166706 A1
(43) Pub. Date: Aug. 26, 2004

(54) SMT-compatible through-hole electrical connector

(76) Inventor: Pei Ren Xu, Dollard-des-Ormeaux (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/373,015

(22) Filed: Feb. 26, 2003

(51) Int. Cl. H01R 12/00

(52) U.S. Cl. 439/82

(57) ABSTRACT

The invention provides an electrical connector for mounting to a circuit board. The electrical connector has a plurality of elongated contact elements mounted to an electrically insulating base that supports the contact elements side-by-side. The base of electrically insulating material includes a circuit board facing side that faces the circuit board when the contact elements are inserted through the circuit board. A spacer adjacent the circuit board facing side engages the circuit board when the contact elements are inserted in the circuit board to maintain a gap between the circuit board and the circuit board facing side of the electrically insulating base.

### FIELD OF THE INVENTION

The invention relates to electric terminals, in particular to an electrical connector with a plurality of contact elements for through-hole mounting on a base of electrically insulating material. The electrical connector is compatible with Surface-Mount Technology (SMT) techniques.

### SUMMARY OF THE INVENTION

In a first broad aspect the invention provides an electrical connector for mounting to a circuit board. The electrical connector has a plurality of elongated contact elements mounted to an electrically insulating base that supports the contact elements side-by-side. The base of electrically insulating material includes a circuit board facing side that faces the circuit board when the contact elements are inserted through the circuit board. A spacer adjacent the circuit board facing side engages the circuit board when the contact elements are inserted in the circuit board to maintain a gap between the circuit board and the circuit board facing side of the electrically insulating base.

The gap remaining between the electrically insulating base and the circuit board is advantageous since, during reflow soldering of the electrical connector to the circuit board, it provides a space through which hot air can circulate to enhance heat transfer to the solder joints between the contact elements and the circuit board. Furthermore, the gap prevents solder paste printed on the circuit board from making contact with the insulating base.

Another advantage of the above arrangement resides in the presence of the base of electrically insulating material that allows using automatic pick and place machines for mounting the electrical connector to the circuit board. The electrically insulating base forms a convenient pick-up surface that can be grasped by the pick and place machine for insertion of the electrical connector in the circuit board.

In a second broad aspect, the invention provides an electrical connector for mounting to a circuit board including a main face and at least one hole though the main face. The electrical connector has at least one elongated contact element, including a first end and a second end and a shank portion extending between the first and the second ends. The shank includes an enlargement. During insertion of the shank in a hole of the circuit board, the enlargement engages a portion of the main face immediately adjacent the hole such that, during soldering of the electrical connector to the circuit board, solder flows on the shank and on the enlargement.

The advantage of this arrangement is the stronger mechanical connection resulting from the provision of the enlargement that provides additional contact area over which the solder joint expands.

In a third broad aspect, the invention further provides a circuit board having a body with a first main face and a second opposite main face. The circuit board further includes a hole extending through the first and second main faces. An electrical connector having at least one elongated contact element is mounted to the circuit board. The contact element has a first end and a second end, and a shank portion therebetween. An enlargement is provided on the shank portion. The shank is inserted in the hole and projects from one of said main faces. A solder joint secures the electrical connector to the body, the solder joint being applied to the shank and extending over at least a portion of the enlargement.

### BRIEF DESCRIPTION OF THE DRAWINGS

A detailed description of examples of implementation of the present invention is provided hereinbelow with reference to the following drawings, in which:

FIG. 1 is a perspective view of an electrical connector in accordance with a first example of implementation of the invention;

FIG. 2 is a perspective view of the electrical connector of FIG. 1, shown partially inserted through a circuit board;

FIG. 3 is an elevational view of an electrical connector according to a second example of implementation of the invention; and

FIG. 4 is an elevational view of an electrical connector according to a third example of implementation of the invention.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

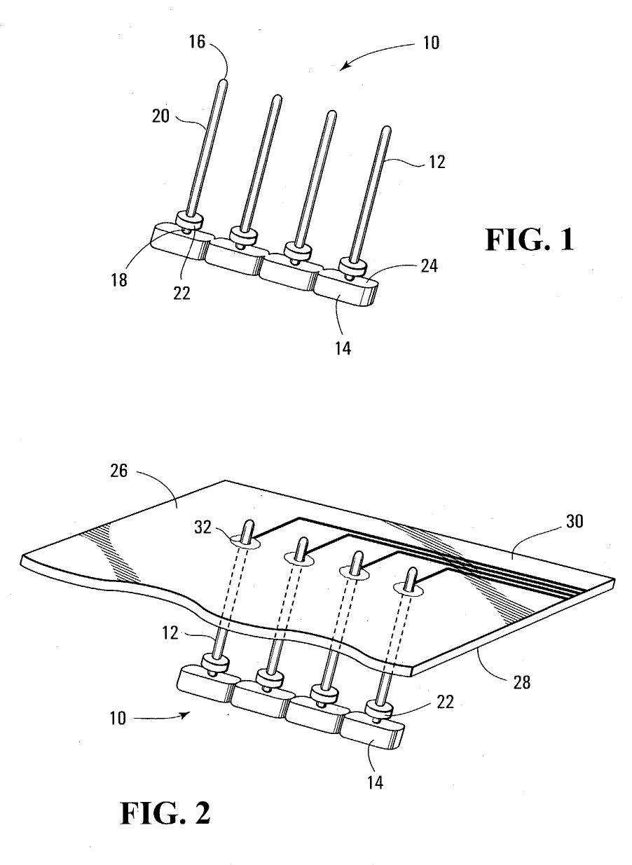

With reference to FIG. 1, the electrical connector 10 includes a plurality of male contact elements 12 mounted to an electrically insulating base 14. The base 14 is made of any suitable synthetic material that preferably will not melt at the temperatures to which it is exposed during soldering of the electrical connector 10 to a circuit board. The base 14 is in the shape of an elongated strip and supports the contact elements 12 side-by-side in a common imaginary plane. Although the electrical connector 10 is shown to include four contact elements 12, the number of contact elements 12 can be varied without departing from the spirit of the invention. Also, the shape and size of the base 14 can be varied widely without departing from the spirit of the invention. For example, the base may be circular or of any other configuration in which the contact elements 12 are held side by side but they do not lie in a common imaginary plane.

Each contact element 12 includes a first end 16, an opposite second end 18 and an elongated shank 20. The shank 20 has an enlargement 22 adjacent the end 18. The enlargement 22 is in the form of an annulus. The shank 20 is of circular cross-sectional shape and has a generally constant transverse dimension over its length except at the area of the enlargement 22. The enlargement 22 can be made of metallic material. For example the enlargement 22 can be made integrally with the shank 20. Alternatively, the enlargement can be made as a separate component that is attached to the shank 20. For example, the enlargement can be in the form of an annular body with a central aperture that is slid on each contact element 12. Although it is preferred to use enlargements that are made of metallic material in order to obtain a stronger solder joint with the circuit board 26, as it will be described later, enlargements made of materials that cannot be soldered can also be used without departing from the invention.

Note that, as shown in FIGS. 1 and 2, each enlargement 22 is positioned on the respective contact element 12 such as to be slightly spaced apart from the base 14, such that there is no contact between the enlargements 22 and the base 14. Alternatively, each enlargement 22 may be positioned on the respective contact element 12 such as to be located immediately adjacent the base 14, such that contact is established between the enlargements 22 and the base 14.

The second end 18 of each contact element 12 is inserted in the base 14 such that the enlargement 22 is adjacent the upper surface 24 of the base 14. Collectively, the enlargements 22 of the contact elements 12 form a spacer that will create a gap between the upper surface 24 of the base 14 and the circuit board when the electrical connector 10 is mounted to the circuit board 26. This will be best understood from FIG. 2.

The circuit board 26 includes a generally planar body with two opposite main faces 28 and 30. A plurality of holes 32 are formed in the body, one for each contact element 12. The holes 32 extend completely through the body from the main face 28 to the main face 30. The electrical connector 10 is mounted to the circuit board 26 by inserting the contact elements 12 through the respective holes 32. The relative dimensions of the holes 32 and the respective shanks 20 is such that the insertion can be made without the necessity of applying a strong force to push the shanks through the circuit board 26, while at the same time avoiding a fit that is too loose and will result in an inaccurate positioning of the electrical connector on the circuit board 26.

The enlargements 22 are sufficiently large to form abutments engaging the surfaces of the main face 28 adjacent the respective holes 32. When the contact elements 12 are fully inserted through the circuit board 26 and the enlargements 22 engage the main face 28, a portion of each shank 20 projects from the main face 30. Once the electrical connector 10 has been soldered to the circuit board 26, as will be described below, the contact elements 12 are then able to mate with other contact elements. In the embodiment of the invention illustrated in the drawings, such other contact elements can be female connectors, however, the invention is not limited to this specific arrangement.

It should be noted that the spacer could function adequately with enlargements 22 on only some of the contact elements 12, and even on a single one of the contact elements 12.

After the electrical connector 10 has been mounted on the circuit board 26 and the enlargements 22 abut against the main face 28, a gap remains between the main face 28 and the upper surface 24 of the base 14, that forms the circuit board facing side of the base 14 in this example of implementation.

The above-described mounting operation can be accomplished by using automatic pick-and-place machines which grasp the electrical connector 10 by the base 14 and insert it through the circuit board 26.

After the electrical connector 10 has been positioned on the circuit board 26, it is soldered thereon.

A preferred soldering technique is reflow soldering. Thus, prior to mounting the electrical connector 10 to the circuit board 26, solder paste is applied to the areas of the circuit board 26 at which solder joints are to be formed, typically through well-known printing techniques. In a specific example, solder paste is printed on the surface of the main face 28 that surrounds-each hole 32.

During reflow soldering, the circuit board 26 and the components applied thereto, including the electrical connector 10 are heated. Various heating methods can be used, including convection heating and infrared heating, among others. During the heating operation, the gap between the base 14 of the electrical connector 10 and the main face 28 of the circuit board 26 prevents solder paste printed on the main face 28 from making contact with the base 14. Furthermore, the gap between the base 14 and the main face 28 allows hot air to better circulate in the area of the contact elements 12 such as to enhance the heat transfer to the solder paste. When the temperature has been sufficiently elevated, the solder paste melts and flows over the shanks of the contact elements 12. In addition, the melted solder paste also flows over the enlargements 22. The resulting solder joint will be stronger because it extends over a larger surface area provided by the enlargements 22, in comparison to a joint that is made only over the shanks 20. Objectively, the stronger joint advantage is obtained when the enlargement 22 is made of material that can be soldered. Embodiments using enlargements made of materials that cannot be soldered will not provide an increased surface area over which the solder can expand.

In a specific, non-limiting example, assume the enlargements 22 are made of a suitable metallic material. The heating method of the reflow soldering process, in combination with a strong air convection arising within the gap between the base 14 and the main face 28, may cause the enlargements 22 themselves, at least in part, to melt and flow. Thus, the melted enlargement 22 material will combine with the melted solder paste from the circuit board 26, in order to form an even stronger solder joint. The solder joint area may also increase, as a result of the additional melted material.

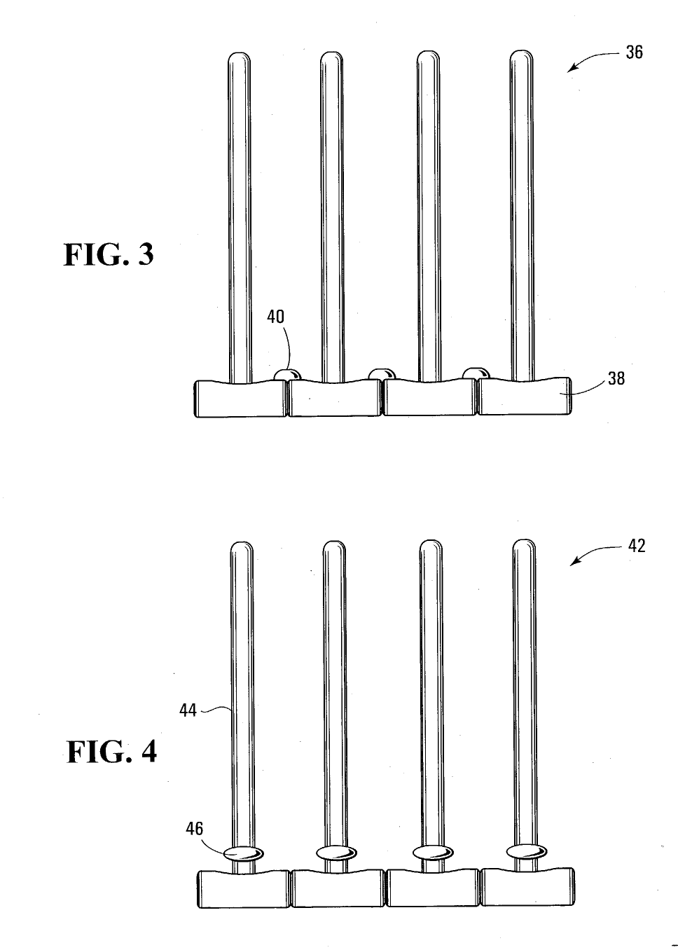

FIG. 3 shows a variant of the electrical connector. The variant, identified by the reference numeral 36, includes a base of electrically insulating material 38 having an integrally formed spacer thereon. The spacer includes a plurality of projections 40 formed on the circuit board facing side of the base 38. When the electrical connector 36 is mounted on the circuit board the projections 40 engage the circuit board to form the gap between the circuit board and the base 38. Note that while the drawings show a spacer formed by three projections, more or less projections can be used without departing from the spirit of the invention.

FIG. 4 shows another variant of the electrical connector. This variant, identified by the reference numeral 42 includes a plurality of contact elements 44, each contact element including a bead shaped enlargement 46 made of solder. The enlargements 44 provide a spacer functionality as described in connection with the embodiment shown at FIGS. 1 and 2, the difference being that during the soldering phase the solder material of the enlargement will melt and migrate toward the circuit board to form a solder joint. Additional solder material may or may not be provided on the circuit board.

It should be noted that although the previous examples illustrate the spacer as including components or elements that are separate or added to the shank of a contact element, the spacer may be formed by the shank itself such as, for example bending the shank at the area where the insertion of the electrical connector through the circuit board should stop.

Although various embodiments have been illustrated, this was for the purpose of describing, but not limiting, the invention. Various modifications will become apparent to those skilled in the art and are within the scope of this invention, which is defined more particularly by the attached claims.

1. An electrical connector for mounting to a circuit board, said electrical connector, comprising:
a plurality of elongated contact elements;
a base of electrically insulating material supporting said contact elements such that they extend side-by-side, said base of electrically insulating material including a circuit board facing side that faces a circuit board when said contact elements are inserted through the circuit board;
a spacer adjacent said circuit board facing side, said spacer capable of engaging the circuit board when said contact elements are inserted through the circuit board to maintain a gap between the circuit board and said circuit board facing side.

2. An electrical connector as defined in claim 1, wherein said contact elements are male pins.

3. An electrical connector as defined in claim 2, wherein said base of electrically insulating material is shaped as a strip.

4. An electrical connector as defined in claim 3, wherein said base of electrically insulating material supports said contact elements such that they lie in a common imaginary plane.

5. An electrical connector as defined in claim 4, wherein said spacer is integrally formed on said base of electrically insulating material.

6. An electrical connector as defined in claim 4, wherein said spacer includes at least one projection on said circuit board facing side.

7. An electrical connector as defined in claim 6, wherein said spacer includes a plurality of projections on said circuit board facing side positioned in a spaced apart relationship on said base of electrically insulating material.

8. An electrical connector as defined in claim 4, wherein said spacer is formed on at least one of said contact elements.

9. An electrical connector as defined in claim 4, wherein said spacer includes an enlargement formed on at least one of said contact elements adjacent said base of electrically insulating material.

10. An electrical connector as defined in claim 9, wherein said at least one contact element is received in a hole of the circuit board, said enlargement has a transverse dimension that exceeds a transverse dimension of the hole.

11. An electrical connector as defined in claim 10, wherein said at least one contact element includes a first end that is remote from said base of electrically insulating material, a second end opposite said first end inserted in said base of electrically insulating material, said at least one contact element having a generally constant transverse dimension over a major portion of a segment from said enlargement to said first end.

12. An electrical connector as defined in claim 10, wherein said enlargement includes a surface that is generally transverse to a longitudinal axis of said at least one connector.

13. An electrical connector as defined in claim 12, wherein said enlargement is annular.

14. An electrical connector as defined in claim 10, wherein said spacer includes a plurality of enlargements on respective ones of said contact elements.

15. An electrical connector for mounting to a circuit board including a main face and at least one hole though the main face, said electrical connector, comprising:
at least one elongated contact element, including:
a) a first end and a second end;
b) a shank portion extending between said first and said second ends;
c) an enlargement on said shank portion;
wherein during insertion of said shank in a hole of the circuit board, said enlargement engages a portion of said main face immediately adjacent the hole such that during soldering of said electrical connector to the circuit board solder flows on said shank and on said enlargement.

16. An electrical connector as defined in claim 15, wherein said electrical connector is mounted to the circuit board using reflow soldering.

17. An electrical connector as defined in claim 16, wherein said enlargement is annular.

18. An electrical connector as defined in claim 17, including a base of electrically insulating material receiving said second end.

19. An electrical connector as defined in claim 18, wherein said enlargement is located closer to said second end than to said first end.

20. A circuit board, comprising:
a body having a first main face and a second opposite main face;
a hole extending through said first and second main faces;
an electrical connector having at least one elongated contact element, said contact element having:
a) a first end and a second end;
b) a shank portion between said first end and said second end;
c) an enlargement on said shank;
said shank being inserted in said hole and projecting from one of said main faces;
a solder joint securing said electrical connector to said body, said solder joint being applied to said shank and extending over at least a portion of said enlargement.

21. A circuit board as defined in claim 20, wherein said enlargement engages a portion of one of said main faces immediately adjacent said hole.

22. A circuit board as defined in claim 21, wherein said enlargement is annular.

23. An electrical connector as defined in claim 22, including a base of electrically insulating material receiving said second end.

24. An electrical connector as defined in claim 23, wherein said enlargement is located closer to said second end than to said first end.

25. A circuit board, comprising:
a body having a first main face and a second opposite main face;
a hole extending through said first and second main faces;
an electrical connector including:
a) at least one elongated contact element, said contact element having:
i) a first end and a second end;
ii) a shank portion between said first end and said second end, said shank portion being inserted in said hole and projecting from one of said main faces;
b) a base of electrically insulating material receiving said shank portion;
c) a spacer between said one of said main faces and said base of electrically insulating material to maintain a gap between the circuit board and said circuit board facing side.

26. A circuit board, comprising:
a body having a first main face and a second opposite main face;
a hole extending through said first and second main faces;
said hole suitable for receiving a shank of a contact element of an electrical connector, the electrical connector having a base of insulating material receiving the shank;
a spacer mounted to one of said main faces adjacent said hole, the spacer being engaged by the base of insulating material when the shank of the contact element is inserted in said hole to maintain a gap between the base of insulating material and said one of said main faces.
